(19) United States
(12) Patent Application Publication
(10) Pub. No.: US 2019/0007383 A1
(43) Pub. Date: Jan. 3, 2019

(54) METHOD OF RECEIVING DATA WITHIN AN ELECTRONIC ENTITY AND ASSOCIATED ELECTRONIC ENTITY

(71) Applicant: IDEMIA FRANCE, Colombes (FR)

(72) Inventors: Jean-Philippe VALLIERES, Colombes (FR); Florian GALDO, Colombes (FR); Emmanuelle DOTTAX, Colombes (FR); Franck RONDEPIERRE, Colombes (FR); Michele SARTORI, Colombes (FR)

(21) Appl. No.: 16/064,394

(22) PCT Filed: Dec. 20, 2016
(86) PCT No.: PCT/FR2016/053581

§ 371 Date: Jun. 20, 2018

(30) Foreign Application Priority Data
Dec. 21, 2015 (FR) 1562996

(51) Int. Cl. H04L 29/06; H04L 9/08; H04L 9/32

(52) U.S. Cl. CPC H04L 63/065; H04L 63/062; H04L 9/32; H04L 9/0866

(57) ABSTRACT

A method for receiving data (DATASEND) within an electronic entity (2) includes the following steps: establishment, between the electronic entity (2) and an external electronic apparatus, of a first secure channel by encipherment by element of a first cryptographic key (SK-ENC); reception, via the first secure channel, of a first command; reception of at least one second cryptographic key (BK-ENC) via the first secure channel; setting up, owing to the execution of the command, of a second secure channel by encipherment by element of the second cryptographic key (BK-ENC); and reception of the data (DATASEND) in the second secure channel. A corresponding electronic entity is also described.

### TECHNICAL FIELD OF THE INVENTION

The present invention relates to secure exchanges of data between electronic devices.

It relates more particularly to a method for receiving data within an electronic entity and to an associated electronic entity.

The invention applies particularly advantageously in the case where identical data have to be communicated securely to a large number of electronic entities.

### TECHNOLOGICAL BACKGROUND

In order to be able to exchange data confidentially between two electronic devices, it is known to establish, between these two electronic devices, a channel secured by encryption by way of a cryptographic key, for which there is provision for example in the protocol termed “SCP03” described in the document “GlobalPlatform Card Technology—Secure Channel Protocol 03—Card Specification v 2.2 Amendment D”(v1.1).

In the context of this protocol, in order to ensure effective protection of the data, the cryptographic key is a session key derived from a static key known only to the two electronic devices.

However, this solution is not suitable for the transmission of one and the same dataset to a large number of electronic entities (as is the case for example in a campaign to update part of the operating system of a large number of secure elements), as it is then necessary to prepare a dedicated encrypted version for each electronic entity in question.

### SUBJECT OF THE INVENTION

In this context, the present invention proposes a method for receiving data within an electronic entity, characterized in that it comprises the following steps:
establishing, between the electronic entity and an external electronic apparatus, a first channel secured by encryption by way of a first cryptographic key;
receiving, via the first secure channel, a first command;
receiving at least one second cryptographic key via the first secure channel;
setting up, as a result of the execution of said first command, a second channel secured by encryption by way of the second cryptographic key;
receiving said data in the second secure channel.

The first secure channel may thus be diversified in order to securely communicate the second cryptographic key to the electronic entity, for example using a protocol of SCP03 type, as indicated above.

Setting up a second secure channel nevertheless makes it possible then to use a different encryption that is based, when desirable, on a second cryptographic key used to encrypt data intended for a large number of electronic entities.

The first secure channel is for example based on a protocol of SCP03 type in non-predictive mode, whereas the second secure channel is for example based on a protocol of SCP03 type in predictive mode.

The second cryptographic key is for example included in the first command.

Other features that may optionally be contemplated are as follows:
after the step of receiving said first command and before the step of setting up the second secure channel, the method comprises a step of saving the first cryptographic key (and for example also associated contextual data) in a memory (for example a random access memory) of the electronic entity (the first cryptographic key and the possible associated contextual data forming restoration data for the first secure channel);
after the step of receiving said data and a second command, the method comprises a step of changing to the first secure channel;
the changing step comprises a sub-step of reading the first cryptographic key saved in the (random access) memory;
after the changing step, the method comprises a step of invalidating restoration data for the first secure channel;
after the changing step, the method comprises a step of waiting for an authorization command in the first secure channel;
after the changing step, the method may comprise a step of receiving an integrity verification code in the first secure channel;
the first cryptographic key is a session key derived from a static key stored in the electronic entity;
the second cryptographic key is a broadcast key used to encrypt a secure channel established by another electronic entity;
the data represent for example part of an operating system, at least part of an application or else data able to be used later by the electronic entity;
the received data are stored within a non-volatile memory of the electronic entity;
the electronic entity is a secure element;
the external electronic apparatus is a mobile terminal or an energy supply meter or a connected object or a portable object.

The invention also proposes an electronic entity, characterized in that it comprises a module for establishing, between the electronic entity and an external electronic apparatus, a first channel secured by encryption by way of a first cryptographic key; a module for receiving, via the first secure channel, a first command and a second cryptographic key; a module for setting up, as a result of the execution of said first command, a second channel secured by encryption by way of the second cryptographic key; and a module for receiving data in the second secure channel.

When the electronic entity comprises a processor, at least some modules may be partly implemented at least by way of computer program instructions stored in a memory of the electronic entity and designed to contribute to the implementation of the functionality of the module in question when these instructions are executed by the processor.

The solution that has just been proposed has the following advantages in particular:
it makes it possible to adjust the security level depending on the demands of the operator, of the manufacturer or else of the supplier of the secure element (choice of the data sent over the diversified or non-diversified channel and also the security elements (e.g. MAC)), thereby allowing the security level to be flexible;
it allows delayed deployment on the terminal. The data are sent in broadcast mode and the authorization command may be sent later so as to trigger the use of the loaded data. With this authorization command, the server (of the supplier or of the manufacturer) still keeps control over the secure element (as, before the authorization, there is an integrity monitoring phase that is carried out). Using the diversified channel for this command makes it possible to address terminals individually and to ensure that the operation is performed in the desired time and with the desired effect;
the provision for saving the context (see step E18 further on) makes it possible not to restart the configuration of the diversified mode when changing from one mode to the other.

Specifically, in the following example, there is provision for saving the context of the diversified mode. In other embodiments, it would nevertheless be possible to provide for saving the context for each of the modes that are used (for example diversified and multi-user) before changing to the other mode.

### DETAILED DESCRIPTION OF ONE EXEMPLARY EMBODIMENT

The following description with reference to the appended drawings, which are given by way of non-limiting example, will give a better understanding as to what the invention consists of and how it is able to be implemented.

In the appended drawings:

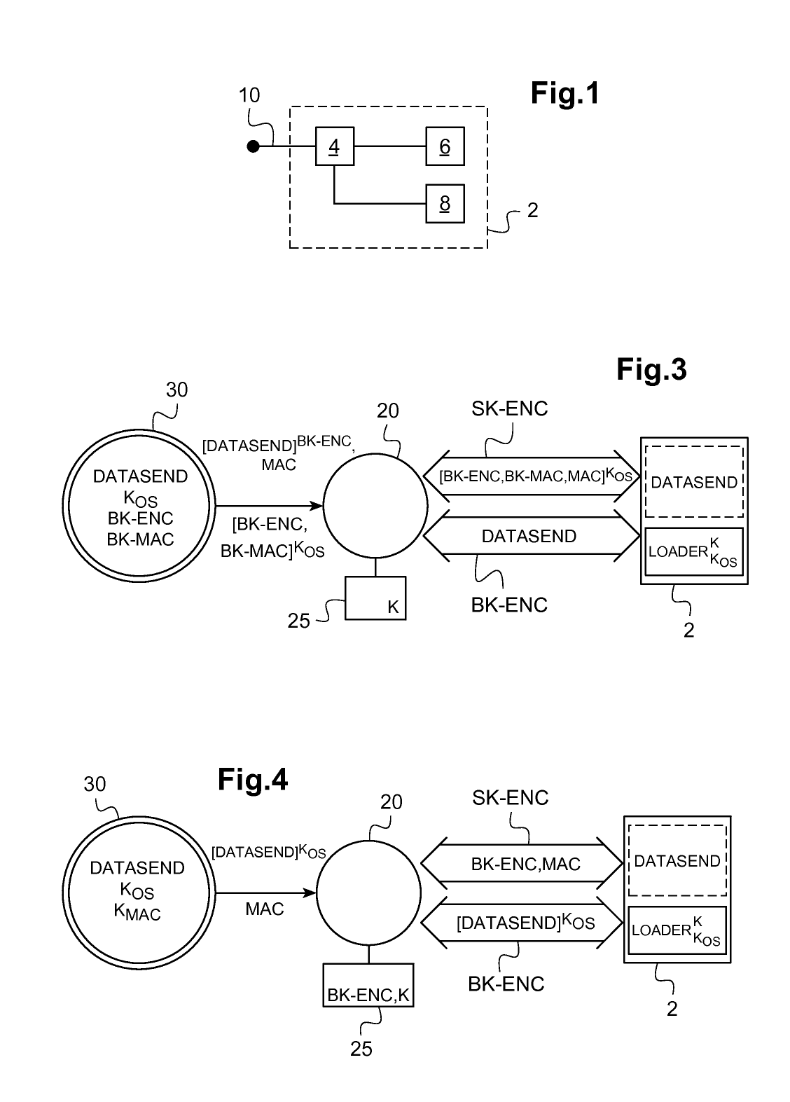

FIG. 1 shows an exemplary secure element used in the context of the invention;

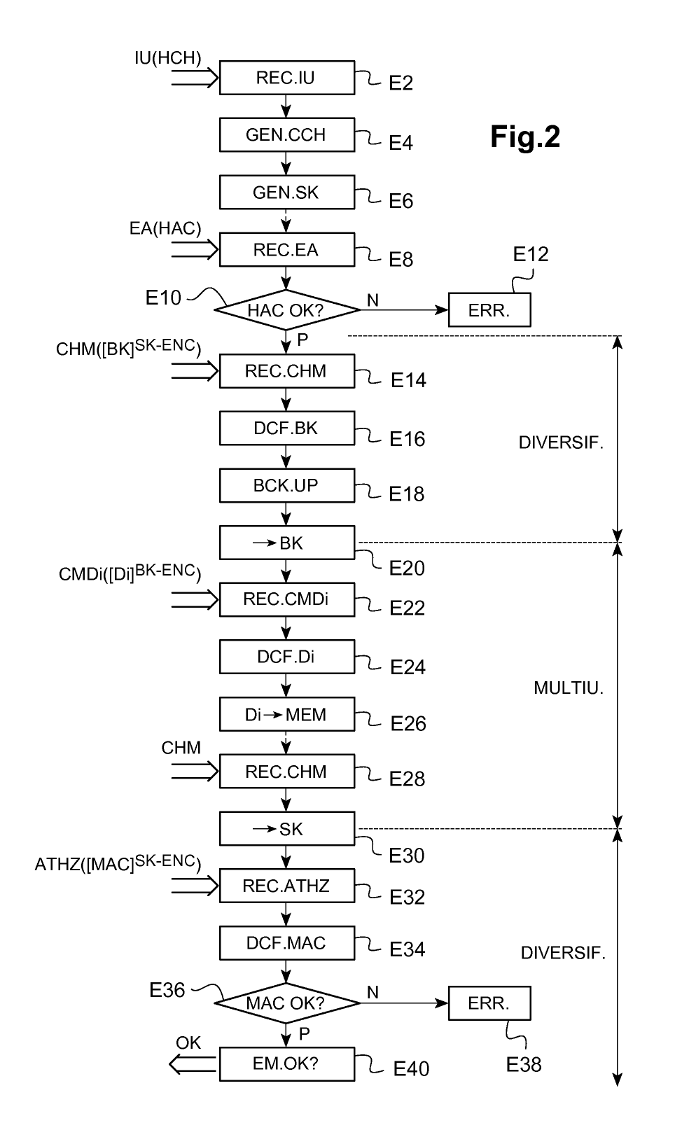

FIG. 2 is a flow chart showing an exemplary method implemented within the secure element of FIG. 1;

FIG. 3 shows a first possible context of use of the method of FIG. 2;

FIG. 4 shows a second possible context of use of the method of FIG. 2; and

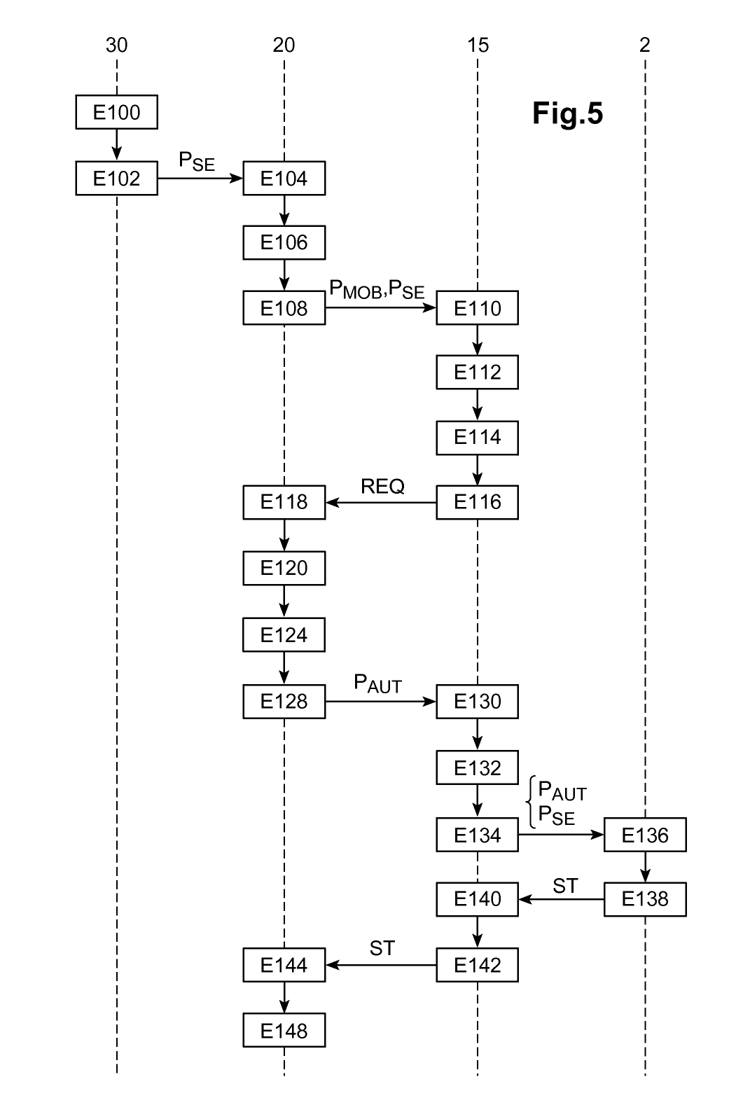

FIG. 5 is a flow chart showing an exemplary method for updating the operating system of the secure element of FIG. 1.

FIG. 1 shows an exemplary secure element 2 used in the context of the invention.

This secure element 2 (or SE) is for example implemented in the form of a microcontroller. Such a secure element 2 may possibly be integrated into an electronic apparatus, for example by being soldered inside the electronic apparatus: the secure element is then of eSE (for “embedded secure element”) type.

As a variant, the secure element 2 could be a microcircuit card (for example a universal microcircuit card or UICC for “universal integrated circuit card”), or a soldered universal microcircuit card or eUICC for “embedded universal circuit card”.

The secure element 2 comprises a processor 4 (for example a microprocessor), a non-volatile memory 6 (for example a rewritable non-volatile memory) and a random access memory 8.

The non-volatile memory 6 is for example of Flash or NVRAM type.

The non-volatile memory 6 stores program instructions that allow the secure element 2 to implement data processing methods (in particular the one described below with reference to FIG. 2) when these instructions are executed by the processor 4.

The non-volatile memory 6 also stores data that are used in the implementation of such methods: the non-volatile memory 6 stores in particular cryptographic keys (called static keys) that are used in the methods described below, in particular a set of static cryptographic keys K.

The random access memory 8 stores data that are manipulated by the methods implemented within the secure element 2.

The secure element 2 also comprises at least one interface 10 that enables the processor 4 to exchange data with other electronic devices. When the secure element 2 is a microcontroller, the interface 10 may be formed by one or more pin(s) of the microcontroller. If the secure element is a microcircuit card, the interface comprises at least one of the contacts exposed on the upper face of the microcircuit card. The interface may also be a port of ISO, SWP or else SPI type.

FIG. 2 shows an exemplary method implemented within the secure element 2.

This method starts at step E2 with the reception, by the processor 4 and on the interface 10, of a launch command IU containing a host challenge HCH.

Such a launch command IU, along with the other commands received by the secure element 2 as mentioned below, have been transmitted beforehand by an electronic apparatus (separate from the secure element 2) that wishes to establish a secure communication channel for the purpose of exchanging secure data with the secure element 2.

The launch command IU is for example a command of INITIALIZE UPDATE type, as defined in paragraph 7.1.1 of the document “GlobalPlatform Card Technology—Secure Channel Protocol 03—Card Specification v 2.2 Amendment D” or in the appendix D.4.1 of the document “GlobalPlatform Card Specification v 2.2”.

Upon reception of the launch command IU, the processor E4 implements steps E4 and E6, which are now described.

In step E4, the processor 4 generates a card challenge CCH, for example through random drawing or, as a variant, through pseudorandom determination. Pseudorandom determination makes it possible to obtain, through calculation on the basis of data stored within the electronic entity 2, a card challenge CCH that is not able to be predicted by an unauthorized third-party entity. Nevertheless, pseudorandom determination for an authorized third party makes it possible to calculate the card challenge and possible to pre-generate it.

In this case, use is made for example of a pseudorandom determination of the card challenge CCH as defined in paragraph 6.2.2.1 of the document “GlobalPlatform Card Technology—Secure Channel Protocol 03—Card Specification v 2.2 Amendment D” (v1.1). In this example, the card challenge CCH is determined on the basis of a sequence counter, of an identifier of the application transmitting the launch command IU and of a cryptographic key K-ENC of the set of static cryptographic keys K stored in the non-volatile memory 6.

In step E6, the processor 4 then generates a set of session keys SK, in this case by using the static keys of the set of static cryptographic keys K stored in the non-volatile memory 6. The processor 4 generates in particular in this step a session encryption or decryption key SK-ENC on the basis of the already-mentioned cryptographic key K-ENC, and in this case also on the basis of the host challenge HCH and of the card challenge CCH, for example in accordance with the provision in paragraph 6.2.1 of the document “GlobalPlatform Card Technology—Secure Channel Protocol 03—Card Specification v 2.2 Amendment D” (v1.1).

The secure element 2 could then possibly return the card challenge CCH generated in step E4 to the electronic apparatus transmitting the commands. When the card challenge CCH is obtained by pseudorandom determination, as described in this case, it is not necessary to transmit the card challenge CCH since the electronic apparatus transmitting the commands is able to obtain the card challenge CCH using the same pseudorandom determination process.

The processor 4 then receives, on the interface 10, an authentication command EA, accompanied by a host cryptogram HAC. This host cryptogram HAC has been determined beforehand within the electronic apparatus transmitting the commands by using a session key S-MAC of the set of session keys, the host challenge HCH (transmitted beforehand with the launch command IU, as indicated above) and the card challenge CCH (obtained in this case by pseudorandom determination, as indicated above).

The launch command EA is for example a command of EXTERNAL AUTHENTICATE type, as defined in paragraph 7.1.2 of the document “GlobalPlatform Card Technology—Secure Channel Protocol 03—Card Specification v 2.2 Amendment D” (v1.1) or in the appendix D.4.2 of the document “GlobalPlatform Card Specification v 2.2”.

In step E10, the processor then verifies whether the received host cryptogram HAC actually corresponds to the expected cryptogram, thereby making it possible to authenticate the electronic apparatus that is sending the commands.

If not, the method continues in step E12, in which the processor 4 ends the exchange without establishing a secure channel.

By contrast, if the received host cryptogram HAC actually corresponds to the expected cryptogram, a secure channel is established between the electronic apparatus transmitting the commands and the secure element 2. This secure channel is deemed to be diversified (see the reference DIVERSIF. in FIG. 2) on account of the fact that the session keys SK used to ensure confidentiality of the exchanges (in particular the session encryption or decryption key SK-ENC) are known only to the electronic apparatus transmitting the commands and to the secure element 2 (and would for example be different if the electronic apparatus transmitting the commands were to wish to establish a secure channel with another secure element).

It is noted that, in the case of the SCP-03 protocol, three diversified keys are used, under the common name SK-ENC, SK-MAC and SK-RMAC.

In step E14, the processor 4 then receives, via this secure channel, a change command CHM, accompanied by a set of broadcast keys BK (and also, in the example described here, by an encryption counter and by a verification code chaining value). In this case, it is proposed to introduce such a change command for example in the form of a dedicated command, called CHANGE MODE.

On account of the fact that the secure channel is established as described above, the data attached to the command (in particular in this case the broadcast keys BK, with for example attached data making it possible to set up a second secure channel) are encrypted by the session encryption or decryption key SK-ENC.

In step E16, the processor 4 thus decrypts the broadcast keys BK by way of an (in this case symmetric) cryptographic decryption algorithm using the session encryption or decryption key SK-ENC (obtained as explained above in step E6). The cryptographic algorithm used is for example of AES type.

In step E18, the processor 4 then saves (denoted BCK.UP in FIG. 2) the context in a dedicated area of the random access memory 8 (or, as a variant, in the non-volatile memory 6). The processor 4 in particular saves, in this dedicated area of the random access memory 8, the session keys SK (including the session encryption or decryption key SK-ENC). In the example described in this case, in which the protocol of the secure channel is of SCP03 type, the processor 4 also saves, in the dedicated area, an encryption counter and a verification code chaining value (“MAC chaining value”) that are associated with the diversified secure channel (and separate from those received in step E14).

In step E20, the processor 4 then changes to a broadcast mode or multi-user mode (see MULTIU. in FIG. 2), in which the broadcast keys BK are used instead of the session keys SK. In this case, use is also made, in this broadcast mode, of the encryption counter and of the chaining value that are received in step E14.

In particular, in this broadcast (or multi-user) operating mode, the electronic apparatus transmitting the commands and the secure element 2 are able to exchange in a secure channel whose confidentiality is ensured through encryption by way of a broadcast encryption or decryption key BK-ENC (used instead of the session encryption or decryption key SK-ENC).

As will be explained hereinafter, this operating mode is called “broadcast” or “multi-user” on account of the fact that the broadcast keys BK are used to process (in particular encrypt) data intended for a plurality (or even a large number) of secure elements.

In step E22, the processor 4 then receives a command CMDi, to which data Di are attached. As already indicated, on account of the change to broadcast mode (or multi-user mode) in step E20, the data attached to the received commands are now encrypted by the broadcast encryption or decryption key BK-ENC.

In step E24, the processor 4 thus decrypts the data Di by applying an (in this case symmetric) cryptographic decryption algorithm using the broadcast encryption or decryption key BK-ENC received in step E14.

The decrypted data Di may thus be used within the secure element 2 (step E26), in this case by being saved in the non-volatile memory 6. As explained further on, it is proposed in this case, for example, that the data Di represent at least part of an application operating system loaded into the secure element 2 from a remote server. Nevertheless, these data could represent, as a variant, an application (that does not form part of the operating system), cryptographic keys or data used by an application component external to the operating system.

Steps E22 to E26 may possibly be reiterated as a result of the reception of a plurality of commands CMDi (for example for N commands CMDi, where i=1 . . . , N as indicated in FIG. 2).

When all of the commands to be implemented in broadcast mode (or multi-user mode) have been received, the processor 4 receives a change command CHM (step E28) for the purpose of returning to diversified mode, for example the abovementioned command of CHANGE MODE type.

Specifically, there is provision in this case for one and the same command to enable the change to broadcast (or multi-user) mode when the processor 4 is operating in diversified mode, and the change to diversified mode when the processor 4 is operating in broadcast mode. As a variant, two separate commands could be provided for implementing these two changes, respectively.

Upon reception of this command, the processor 4 reads the session keys SK in the abovementioned area of the random access memory 8 (where these session keys have been saved in step E18, as explained above), as well as the encryption counter and the chaining value in this case, and changes, in step E30, to diversified mode using these session keys SK. The processor 4 may thus use the secure channel set up by steps E2 to E10 again. There may then possibly be provision, following this change to diversified mode, for the restoration data to be invalidated (for example erased), such that it will not be possible to perform such a change again later.

In step E32, the processor 4 then receives an authorization command ATHZ to which there is attached an integrity verification code MAC allowing verification of the data Di that are installed (that is to say stored, in this case in the non-volatile memory 6) in step E26, possibly during several executions of this step. Examples of obtaining the integrity verification code MAC are given below.

The authorization command is for example a new command that it is proposed to introduce in this case, under the name AUTHORIZE_ACTION.

With the authorization command ATHZ forming part of the exchanges in the abovementioned secure channel, the data attached to this command (in this case the integrity verification code MAC) are encrypted by way of the session encryption or decryption key SK-ENC.

In step E34, the processor 4 thus decrypts the integrity verification code MAC by applying an (in this case symmetric) cryptographic decryption algorithm using the session encryption or decryption key SK-ENC. The cryptographic algorithm is in this case an algorithm of AES type.

In step E36, the processor 4 may then verify the integrity of the data Di stored in the non-volatile memory 6 during the execution(s) of step E26 by using the decrypted integrity verification code MAC.

If the verification of step E36 fails, the processor 4 does not use the data Di, but implements an error processing operation in step E38, for example by returning an error message to the electronic apparatus responsible for generating the commands, for example a remote server.

If the verification of step E36 succeeds, the processor 4 commands for example the transmission, in step E40, via the interface 10, of a correct operation message. During its operation, the processor 4 will then use the data Di stored in the non-volatile memory 6 in step E26. In the examples described hereinafter, at least some parts of the application operating system represented by the data Di will be executed by the processor 4.

FIGS. 3 and 4 show two possible contexts of use of a method such as has just been described.

In these two contexts, it is desired to securely install, in the secure element 2 (that is to say load into the non-volatile memory 6), an application part DATASEND of an operating system, or else of an application. A primary part LOADER on the secure element 2 (that is to say stored in the non-volatile memory 6) is for example in this case responsible for loading the sent data. In one embodiment, the sent data may be used by the secure element 2 without deploying the primary part LOADER (this is the case for example for a standalone application that is able to execute without intervention by the primary part LOADER after loading). In another embodiment, the primary part LOADER could also be used to launch the deployment of the loaded data.

The application part DATASEND is available in a design computer system 30. This design computer system 30 is for example managed by the manufacturer of the secure element 2. The design computer system 30 has a high security level.

The application part DATASEND has to be transmitted to the secure element 2 via a management server 20, for example managed by a mobile telephony manufacturer or operator. The secure element 2 is precisely associated with this mobile telephony manufacturer or operator. Precisely, the secure element 2 stores data that allow a user terminal bearing the secure element 2 to access at least one mobile telephony network operated by the mobile telephony operator.

The abovementioned user terminal is not mentioned in FIGS. 3 and 4 for the sake of simplicity. It is nevertheless understood that the exchanges of data between the management server 20 and the secure element 2 use telecommunication means of the user terminal (and also possibly the abovementioned mobile telephony network).

The management server 20 has a medium security level. Nevertheless, there is provision for a security module 25 that is linked (via a secure link) to the management server 20 (for example by way of a wired link, in this case of Ethernet type) and that has, for its part, a high security level.

The security module 25 is for example of HSM (for “hardware security module”) type.

In the case of FIG. 3 and FIG. 4, the security module 25 stores the set of static keys K associated with the secure element 2 (and also stored in the non-volatile memory 6 of the secure element 2, as already indicated). It is noted that the security module 25 stores (or is able to obtain, for example by derivation from an identifier of the secure element and of a master key) a specific set of static keys K for any secure element managed by the management server 20.

As shown in FIGS. 3 and 4, the design computer system 30 and the secure element 2 store a symmetric key K_{OS}, in this case common to a large number of secure elements and used to encrypt the application parts DATASEND to be installed on these secure elements. This shared key K_{OS} is managed by the manufacturer of the secure elements 2 and remains confined within these secure elements 2 and the design computer system 30.

A description is now given of the features specific to the solution of FIG. 3.

In the example of FIG. 3, the design computer system 30 also stores the set of broadcast keys (or campaign keys) BK, which in this case comprises the already-mentioned broadcast encryption or decryption key BK-ENC and a broadcast key BK-MAC that is designed to generate an integrity verification code. These broadcast (or campaign) keys BK are used for all of the secure elements that have to receive the application part DATASEND (that is to say in practice an update for their operating system or else an update for an application).

The design computer system 30 may therefore transmit to the management server 20:
the application part DATASEND, encrypted by applying an (in this case symmetric) cryptographic encryption algorithm using the broadcast encryption or decryption key BK-ENC;
the integrity verification code MAC, determined on the basis of the broadcast key BK-MAC and of the application part DATASEND;
the broadcast keys BK-ENC, BK-MAC, encrypted by applying an (in this case symmetric) cryptographic encryption algorithm using the shared key K_{OS}.

It is noted that these elements are common to all of the secure elements that have to receive the application part DATASEND (for example during an update of the operating system of these secure elements) and that the design computer system 30 therefore does not need to generate an encrypted version of the application part DATASEND for each secure element to be updated.

The management server 20 transmits the encrypted broadcast keys BK-ENC, BK-MAC to the security module 25 in order that these data are encrypted by applying an (in this case symmetric) cryptographic encryption algorithm using a session encryption or decryption key SK-ENC. This session encryption or decryption key SK-ENC is obtained in parallel within the security module 25 and within the secure element 2 (as already described above) on the basis in particular of a static key K-ENC of the set of static keys K (which static key is stored in the security module 25 and in the non-volatile memory 6 of the secure element 2).

Only the broadcast keys BK-ENC, BK-MAC and the integrity verification code MAC are encrypted in a diversified manner (that is to say by producing an encrypted version for each secure element to be updated), and the processing operations in the security module 25 are therefore limited (in comparison in particular with a situation in which an encrypted version of the whole application part DATASEND would have to be generated for each secure element to be updated).

It is noted that, in this example, the broadcast keys BK-ENC, BK-MAC are transmitted in double-encrypted form (encrypted by the shared key K_{OS} and encrypted by the session key SK-ENC).

The broadcast keys BK-ENC, BK-MAC may then be transmitted from the management server 20 to the secure element 2 in accordance with step E14 of FIG. 2, after establishing a secure link in accordance with steps E2 to E10 of FIG. 2.

The broadcast keys BK-ENC, BK-MAC are decrypted within the secure element 2, firstly using the session encryption or decryption key SK-ENC (as indicated in step E16 of FIG. 2) and secondly, in this case, using the shared key K_{OS} (stored within the non-volatile memory 6, as already mentioned).

The application part DATASEND may then be transmitted from the management server 20 to the secure element 2 (this application part DATASEND being encrypted by way of the broadcast encryption or decryption key BK-ENC, as indicated above).

The secure element 2 receives, decrypts and stores (in the non-volatile memory 6) the application part DATASEND in accordance with steps E22 to E26 of FIG. 2 (the application part DATASEND possibly being distributed into several blocks of data Di, where i=1, . . . , N).

The secure element 2 may then receive the integrity verification code MAC (in this case encrypted by the symmetric key K_{OS}) from the management server 20 via the secure channel through the session encryption or decryption key SK-ENC, and then verify the integrity of the application part DATASEND by using the integrity verification code MAC and the broadcast key BK-MAC, in accordance with steps E32 to E36 of FIG. 2.

A description is now given of the features specific to the solution of FIG. 4.

In the example of FIG. 4, the design computer system 30 stores a shared integrity key K_{MAC} that is stored in a large number of secure elements and used to verify the integrity of the application parts DATASEND installed on these secure elements. This shared integrity key K_{MAC} is managed by the manufacturer of the secure elements 2 and remains confined within these secure elements 2 and the design computer system 30.

The design computer system 30 may therefore transmit to the management server 20:
the application part DATASEND, encrypted by applying an (in this case symmetric) cryptographic encryption algorithm using the shared key K_{OS};
the integrity verification code MAC, determined on the basis of the shared integrity key K_{MAC} and of the application part DATASEND.

The security module 25 associated with the management server 20 for its part stores (in addition to the set of static keys K) a broadcast (or campaign) encryption or decryption key BK-ENC.

The security module 25 may therefore establish a secure channel (through encryption by way of a session encryption or decryption key SK-ENC generated on the basis of the static key K-ENC) with the secure element 2 in accordance with steps E2 to E10 of FIG. 2, and then transmit the broadcast encryption or decryption key BK-ENC via this secure channel for reception by the secure element 2, in accordance with step E14 of FIG. 2.

The management server 20 then transmits the encrypted application part DATASEND via the multi-user secure channel (using an encryption by way of the broadcast encryption or decryption key BK-ENC), in accordance with steps E22 to E26 of FIG. 2 (the application part DATASEND possibly being distributed into a plurality of blocks of data Di, where i=1, . . . , N).

It is noted that the data Di obtained after decryption by way of a decryption algorithm using the broadcast encryption or decryption key BK-ENC in this case represent (at least part of) the application part DATASEND encrypted by way of the shared key K_{OS}. The processor 2 in this case therefore also decrypts the application part DATASEND by applying a decryption algorithm using the shared key K_{OS}.

The application part DATASEND is then stored in the non-volatile memory 6 (this corresponding to step E26 of FIG. 2).

Lastly, the secure element 2 receives the integrity verification code MAC from the management server 20 via the secure channel through the session encryption or decryption key SK-ENC, and then verifies the integrity of the application part DATASEND by using the integrity verification code MAC and the shared integrity key K_{MAC}, in accordance with steps E32 to E36 of FIG. 2.

It is noted that, in the example of FIG. 3 and in that of FIG. 4, the steps of FIG. 2 that are used are implemented as a result of the execution of instructions of the primary operating system LOADER by the processor 2.

Moreover, in the examples described above, the session encryption or decryption key SK-ENC is a symmetric key obtained by derivation from a static key K-ENC stored both in the secure element 2 and in the electronic apparatus (in this case the security module 25) wishing to establish a secure channel with the secure element 2.

Nevertheless, there may be provision, as a variant, for the session encryption or decryption key SK-ENC to be a symmetric key obtained, in the secure element 2, by derivation in particular from a private key k_{SE} stored in the secure element 2 and, in the electronic apparatus, by derivation in particular from another private key K_{EXT} stored in this electronic apparatus, in accordance with a public key-based key negotiation technique, for which there is provision for example in the document “Card Secure Channel Protocol ‘11’ Card Specification v2.2—Amendment F (v1.0)”.

FIG. 5 is a flow chart showing an exemplary method for updating the operating system of the secure element 2.

This method starts at step E100 by preparing, within the design computer system 30, a dataset P_{SE} to be loaded into the non-volatile memory 6 of the secure element 2.

This dataset P_{SE} in this case contains the application part DATASEND of the operating system to be updated. The dataset P_{SE} is for example formed, to this end, of N write commands CMDi each containing part of the application part DATASEND in a form encrypted by a broadcast (or campaign) key BK-ENC. A command CHM (without an attached cryptographic key), as mentioned in step E28 of FIG. 2, may also be placed at the end of the sequence of the N write commands CMDi.

The broadcast key BK-ENC is used for a large number of secure elements, and the prepared data will therefore be able to be sent (as explained hereinafter) in identical form to all of these secure elements in order to update their operating system.

In step E102, the design computer system 30 transmits the dataset P_{SE} to the management server 20.

The management server 20 receives the dataset P_{SE} in step E104 and in this case, in step E106, combines this dataset P_{SE} with another dataset P_{MOB} intended to be loaded on the user terminal 15 (for example a mobile telephone or cellular telephone) bearing the secure element 2.

In step E108, the management server 20 transmits the datasets P_{SE}, P_{MOB} to the user terminal 15 (for example using in particular the mobile telephony network associated with the management server 20 and with the secure element 2).

The user terminal 15 receives the datasets P_{SE}, P_{MOB} in step E110. To this end, there may be provision for example for the operation of the user terminal 15 to change from a rich execution environment or REE to a trusted execution environment or TEE (set up for example as a result of the execution of a trusted operating system), and for the datasets P_{SE}, P_{MOB} to be received in the context of the execution of an application (for example of ‘midlet’ type) within this trusted execution environment.

The user terminal 15 extracts the dataset P_{SE} from the received data P_{SE}, P_{MOB} in step E112 and processes said other dataset P_{MOB} in step E114, for example by storing these data in a memory of the user terminal 15.

In step E116, the user terminal 15 then transmits (for example at a later moment of the operation) an update authorization request REQ to the management server 20. This request REQ is received by the management server 20 in step E118.

In step E124, the management server 20 then prepares an authorization dataset P_{AUT}.

This authorization dataset P_{AUT} comprises for example the broadcast key BK-ENC encrypted by a cryptographic key specifically associated with the secure element 2, for example a session key SK-ENC that only the management server 20 and the secure element 2 are able to generate.

The authorization dataset P_{AUT} is implemented in this case in the form of the sequence of commands IU, EA, CHM, ATHZ presented above with reference to FIG. 2.

The management server 20 transmits the authorization dataset P_{AUT} to the user terminal 15 in step E128.

The user terminal 15 receives the authorization dataset P_{AUT} in step E130.

In step E132, the user terminal 15 may then combine the dataset P_{SE} (received in step E110 and extracted in step E112) and the authorization dataset P_{AUT}, in this case by inserting the commands of the dataset P_{SE} immediately after the mode change command CHM of the authorization dataset P_{AUT}.

Specifically, as explained above, the data contained in the commands of the dataset P_{SE} are encrypted by way of the broadcast key BK-ENC shared by a plurality of secure elements (in practice, a large number of secure elements), and these commands therefore have to be received after switching of the secure element 2 to multi-user mode.

In step E134, the user terminal 15 sends the commands that are prepared (through combination) in step E132 to the secure element 2. For the sake of simplicity, the successive sending of these commands is shown in just one step in FIG. 5. In practice, each step is sent separately from the user terminal 15 to the secure element 2.

The secure element 2 successively receives and executes each of the commands, as described above with reference to FIG. 2 (shown schematically by step E136).

Once all of the commands have been executed, the secure element 2 transmits an item of state information ST (step E138), as explained above with regard to step E40 of FIG. 2.

The item of state information ST is received by the user terminal 15 in step E140 and transmitted to the management server 20 in step E142.

The management server 20 receives the item of state information ST in step E144 and performs a processing operation on the basis of the item of state information ST, for example by authorizing the user terminal equipped with the secure element 2 to access the mobile telephony network if the item of state information ST confirms correct updating of the operating system of the secure element 2 and by performing other actions (for example: new attempt to load, barring of access to the network for the user terminal 15 in question) if the item of state information ST does not confirm correct updating.

The authorization data P_{AUT} make it possible for example to activate functionalities defined by the datasets P_{SE}, P_{MOB}.

The method that has just been described thus makes it possible to minimize exchanges at the moment when these functionalities are activated. Specifically, by virtue of the prior loading of the datasets P_{SE}, P_{MOB} in steps E100 to E114, the only data transmitted at the moment of activation are the authorization data P_{AUT}.

1. A method for receiving data within an electronic entity, said method comprising the following steps:
establishing, between the electronic entity and an external electronic apparatus, a first channel secured by encryption by way of a first cryptographic key;
receiving, via the first secure channel, a first command;
receiving at least one second cryptographic key via the first secure channel;
setting up, as a result of the execution of said first command, a second channel secured by encryption by way of the second cryptographic key;
receiving said data in the second secure channel.

2. The method as claimed in claim 1, comprising, after the step of receiving said first command and before the step of setting up the second secure channel, a step of saving the first cryptographic key in a memory of the electronic entity.

3. The method as claimed in claim 1, comprising, after the step of receiving said data and a second command, a step of changing to the first secure channel.

4. The method as claimed in claim 2, comprising, after the step of receiving said data and a second command, a step of changing to the first secure channel, wherein the changing step comprises a sub-step of reading the first cryptographic key saved in the memory.

5. The method as claimed in claim 3, comprising, after the changing step, a step of invalidating restoration data for the first secure channel.

6. The method as claimed in claim 3, comprising, after the changing step, a step of waiting for an authorization command in the first secure channel.

7. The method as claimed in claim 6, comprising a step of checking an integrity verification code in the first secure channel.

8. The method as claimed in claim 1, wherein the first cryptographic key is a session key derived from a static key stored in the electronic entity.

9. The method as claimed in claim 1, wherein the second cryptographic key is a broadcast key used to encrypt a secure channel established by another electronic entity.

10. The method as claimed in claim 1, wherein the data represent part of an operating system of the electronic entity or at least part of an application or data able to be used later by the electronic entity.

11. The method as claimed in claim 1, wherein the received data are stored within a non-volatile memory of the electronic entity.

12. The method as claimed in claim 1, wherein the electronic entity is a secure element.

13. The method as claimed in claim 1, wherein the external electronic apparatus is a mobile terminal or an energy supply meter or a connected object or a portable object.

14. An electronic entity, comprising:
a module for establishing, between the electronic entity and an external electronic apparatus, a first channel secured by encryption by way of a first cryptographic key;
a module for receiving, via the first secure channel, a first command and a second cryptographic key;
a module for setting up, as a result of the execution of said first command, a second channel secured by encryption by way of the second cryptographic key;
a module for receiving data in the second secure channel.
